(19) United States
(12) Patent Application Publication
(10) Pub. No.: US 2024/0247671 A1
(43) Pub. Date: Jul. 25, 2024

(54) CONNECTION FITTING FOR CONNECTING TWO FURNITURE PARTS

(71) Applicant: Häfele SE & Co KG, Nagold (DE)

(72) Inventors: Robert Birkner, Berlin (DE); Lorenz Arnold, Unterägeri (CH)

(73) Assignee: Häfele SE & Co KG, Nagold (DE)

(21) Appl. No.: 18/627,690

(22) Filed: Apr. 5, 2024

Related U.S. Application Data
(63) Continuation of application No. PCT/EP2022/074415, filed on Sep. 2, 2022.

(30) Foreign Application Priority Data
Oct. 7, 2021 (DE) 20 2021 105 426.3

(51) Int. Cl. F16B 12/32

(52) U.S. Cl. CPC F16B 12/32

(57) ABSTRACT

A fitting part of a connection fitting has a main body and at least one mounting face. A first mounting face is disposed on a first longitudinal end and is arranged parallel or at an angle to the fastening face and has a latching element. A second mounting face is disposed on a second longitudinal end and is arranged with respect to the fastening face at an inclination about the longitudinal axis or an axis extending parallel thereto, and has a latching element. A third mounting face is formed by a groove base of a transverse groove in the main body and is arranged parallel or at an angle to the fastening face and has a latching element. A fourth mounting face is formed on another longitudinal face of the main body, and is arranged parallel or perpendicular to the fastening face and has a comb-like surface profile.

### CROSS-REFERENCE TO RELATED APPLICATIONS

This continuation application claims priority to PCT/EP2022/074415 filed on Sep. 2, 2022 which has published as WO 2023/057139 A1 and also the German application number 20 2021 105 426.3 filed on Oct. 7, 2021, the entire contents of which are fully incorporated herein with these references.

### DESCRIPTION

### Field of the Invention

The invention relates to a fitting part of a connection fitting for connecting two parts, in particular two furniture parts, having a main body with a longitudinal axis, with at least one longitudinal face which forms a planar fastening face for bearing against and fastening to a part to be connected, and with at least one mounting face for bearing against a counter-mounting face of a further fitting part of the connection fitting. The invention further relates to a connection fitting comprising at least two such fitting parts and an arrangement, in particular a furniture arrangement, comprising two parts, in particular furniture parts, which are connected together by means of the connection fitting according to the invention.

### Background of the Invention

Such two-part connection fittings for connecting two furniture parts are well known.

### SUMMARY OF THE INVENTION

The object of the invention accordingly is to specify a universal fitting part and an associated connection fitting by which two parts can be fastened to one another in as many different orientations as possible.

This object is achieved according to the invention by a fitting part of a connection fitting for connecting two parts, in particular two furniture parts, having a main body with a longitudinal axis, with at least one longitudinal face which forms a planar fastening face for bearing against and fastening to a part to be connected, and wirh at least one mounting face for bearing against a counter-mounting face of a further fitting part of the connection fitting, wherein the main body according to the invention has at least one of the following mounting faces: a first mounting face, which is disposed on a first longitudinal end of the main body, is arranged parallel or at an angle to the fastening face, in particular perpendicular thereto, and has at least one latching element; a second mounting face, which is disposed on a second longitudinal end of the main body, is arranged with respect to the fastening face at an inclination about the longitudinal axis or an axis extending parallel thereto, and has at least one latching element; a third mounting face, which is formed by a groove base of a transverse groove in the main body, said groove being open on one or both sides, is arranged parallel or at an angle to the fastening face, in particular perpendicular thereto, and has at least one latching element; and a fourth mounting face, which is formed on another longitudinal face of the main body, is arranged parallel or perpendicular to the fastening face and, when viewed in the transverse direction, has a comb-like surface profile.

According to the invention the main body can have one, two, three or all four mounting faces.

Preferably, the main body is cuboidal at least in some portions with four longitudinal faces, wherein one, or more or all four longitudinal faces in each case form a fastening face.

Preferably, when viewed in the direction of the longitudinal axis, the main body has an outer contour with a rectangular envelope, in particular with a square envelope.

Preferably, the first mounting face is disposed on a first longitudinal end of the main body and the second mounting face is disposed on a second longitudinal end of the main body. In a preferred embodiment, the first and the second mounting face are arranged so as to be rotated relative to one another about the longitudinal axis or an axis parallel thereto, in particular rotated by 45°.

Preferably, the first, the second and/or the third mounting faces in each case have the same latching arrangement of a plurality of latching elements. In a preferred embodiment, the latching arrangement has a plurality of latching elements arranged around a center, and has a multiple rotational symmetry, in particular a rotational symmetry of order 4, relative to the center. In a further preferred embodiment, the latching arrangement is a circle on which latching protrusions and latching recesses are alternately arranged in each case at equal angular spacings, in particular at 45° angular spacings. Further, a through-hole of the respective mounting face can be arranged in the center of the latching arrangement.

Preferably, a groove width of the transverse groove extending in the direction of the longitudinal axis is equal to a groove length of the transverse groove extending transversely to the longitudinal axis and/or equal to the width of the one or more longitudinal ends.

Preferably, one of the two groove walls of the transverse groove is formed by a spring web which is formed on the groove base and which at its free web end has a latching element. In a preferred embodiment, the main body has a latching element on a longitudinal face, the transverse groove being open relative thereto transversely to the longitudinal axis and said latching element being complementary to the latching element of the spring web. In a further preferred embodiment, the main body has a latching element on the front face of the step between the first mounting face and a longitudinal face, said latching element being complementary to the latching element of the spring web.

Preferably, the at least one longitudinal face, in particular each longitudinal face of the main body which forms a fastening face, has at least one through-hole, in particular a plurality of through-holes.

The invention further relates to a connection fitting with two fitting parts which are configured as above, in particular, to be structurally the same.

The invention finally also relates to an arrangement, in particular a furniture arrangement, comprising two parts, in particular furniture parts, which are connected together by means of a connection fitting which is configured as above, wherein a first fitting part of the connection fitting bears with its fastening face against the one first part and is fastened thereto and a second fitting part of the connection fitting bears with its fastening face against the other second part and is fastened thereto and wherein the first, the second or the third mounting face of the first fitting part and the first, the second or the third mounting face of the second fitting part bear against one another and are latched together by means of the latching elements, or the fourth mounting face of the first fitting part and the fourth mounting face of the second fitting part bear against one another and engage in one another by means of the comb-like surface profiles.

Preferably, the first and the second fitting part are screwed onto the parts by means of screws which engage through through-holes of the fastening face.

Preferably, the first, the second or the third mounting face of the first fitting part and the first, the second or the third mounting face of the second fitting part are screwed together by means of screws which engage through through-holes of the mounting faces.

Further features and advantages of the invention are found in the following description of exemplary embodiments of the invention, with reference to the figures of the drawing which show details which are essential to the invention, and in the claims. The features mentioned above and set forth below in more detail can also be used individually or together in any combinations thereof. The exemplary embodiments which are shown and described are not to be understood as a definitive list but rather have an exemplary character for illustrating the invention.

### BRIEF DESCRIPTION OF THE DRAWINGS

In the drawing:

FIGS. 1a-1f show a fitting part according to the invention in two perspective views of different longitudinal faces of the fitting part (FIGS. 1a, 1b) in two plan views of different longitudinal faces of the fitting part (FIGS. 1c, 1d) and in two side views of the two front faces of the fitting part (FIGS. 1e, 1f);

FIGS. 2a-2f show a connection fitting according to the invention with two or three fitting parts according to the invention which are connected together in each case in a different angular orientation;

FIG. 3 shows a connection fitting according to the invention with two fitting parts according to the invention which are inserted into one another;

FIG. 4 shows a connection fitting according to the invention with two fitting parts according to the invention which are engaged in one another;

FIGS. 5a-5c show the connection fitting shown in FIG. 4 with a different transverse offset of the two fitting parts in each case;

FIGS. 6a, 6b show a furniture arrangement according to the invention with two furniture parts which are connected together by means of the connection fitting according to the invention;

FIGS. 7a, 7b show a furniture arrangement according to the invention with two furniture parts which are arranged by means of the connection fitting according to the invention with a gap dimension of 4 mm; and

FIG. 8 shows a furniture arrangement with three furniture parts, wherein the central furniture part is fastened in each case by two connection fittings according to the invention to the two other furniture parts.

### DETAILED DESCRIPTION OF EMBODIMENTS OF THE INVENTION

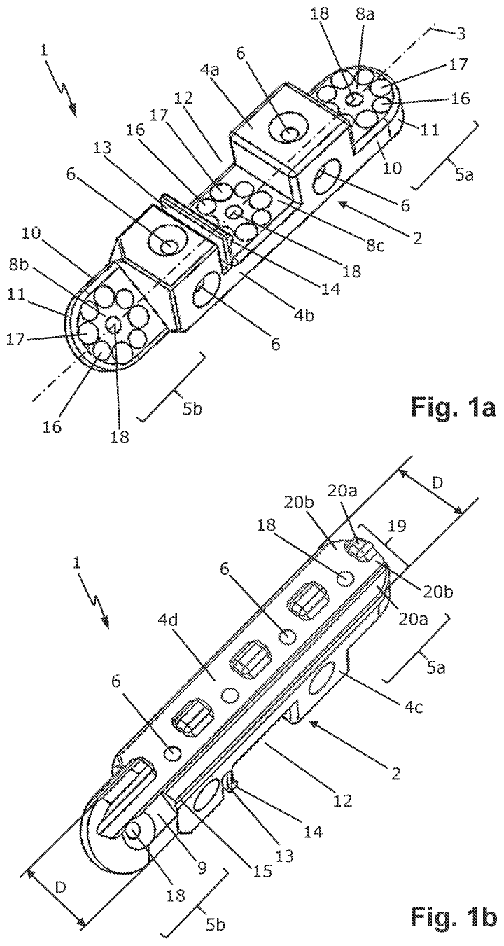

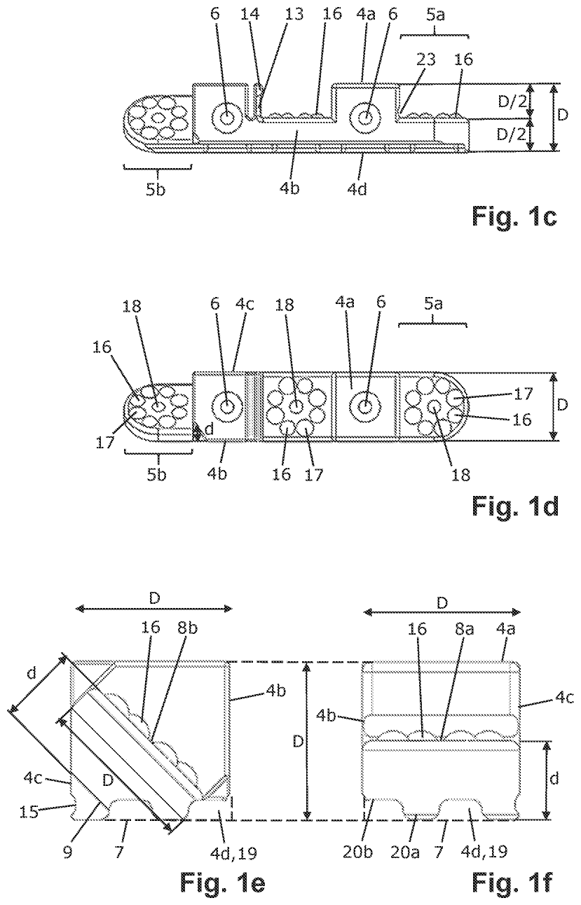

The fitting part 1 shown in FIGS. 1a-1f serves for connecting differently oriented furniture parts. The fitting part 1 has an elongated main body 2 which is cuboidal at least in some portions with a longitudinal axis 3 with four longitudinal faces 4a-4d, in each case parallel in pairs, and with two longitudinal ends 5a, 5b. At least one of the four longitudinal faces 4a-4d forms a planar fastening face, by which the fitting part 1 bears against a furniture part and is able to be fastened thereto. In the exemplary embodiment shown, all four longitudinal faces 4a-4d form in each case a planar fastening face, the fitting part 1 being able to be fastened thereby to a furniture part. To this end, each longitudinal face of the main body 2 which forms a fastening face has one or more, in this case two, through-holes 6 (for example, at 32 mm spacings).

As shown in FIGS. 1e and 1f, when viewed in the direction of the longitudinal axis 3, the main body 2 has an outer contour with a square envelope 7 shown in dashed lines with an edge length D.

The main body 2 has on its one first longitudinal end 5a a first mounting face 8a and on its other second longitudinal end 5b a second mounting face 8b, wherein the mounting faces 8a, 8b are formed in each case by a stepped portion of the main body 2. The first mounting face 8a is arranged parallel to the longitudinal faces 4a, 4d and perpendicular to the longitudinal faces 4b, 4c. Relative to the longitudinal faces 4a-4d, the second mounting face 8b is inclined in each case about the longitudinal axis 3, in this case merely by way of example respectively by 45°. The first and the second mounting faces 8a, 8b are arranged so as to be rotated relative to one another about the longitudinal axis 3 by 45°, wherein the longitudinal axis 3 of the main body 2 is located in the plane of the first and second mounting faces 8a, 8b.

The rear face of the first longitudinal end 5a opposing the first mounting face 8a is formed by the longitudinal face 4d parallel to the first mounting face 8a. The rear face of the second longitudinal end 5b opposing the second mounting face 8b, however, is formed by a separate rear face 9 parallel to the second mounting face 8b. The thickness of the longitudinal ends 5a, 5b, i.e., in the case of the first longitudinal end 5a the spacing of the first mounting face 8a from the longitudinal face 4d and in the case of the second longitudinal end 5b the spacing of the second mounting face 8b from the rear face 9, corresponds to half the edge length D of the main body 2, i.e., D/2 (FIG. 1c). When viewed in the direction of the longitudinal axis 3, the longitudinal ends 5a, 5b have in each case an inner portion 10, the width thereof being equal to the edge length D of the main body 2 (FIG. 1e) and an outer portion 11 which adjoins thereto on the outside and which is rounded on the front face.

Moreover, the main body 2 also has, preferably centrally, between its two longitudinal ends 5a, 5b a third mounting face 8c which is formed by the groove base of a transverse groove 12, said transverse groove being open on both sides and said third mounting face being arranged parallel to the longitudinal faces 4a, 4d and perpendicular to the longitudinal faces 4b, 4c. The first and the third mounting faces 8a, 8c are arranged in the same plane so that the longitudinal axis 3 is also located in the plane of the third mounting face 8c. The groove width extending in the direction of the longitudinal axis 3 and the groove length of the transverse groove 12 extending transversely to the longitudinal axis 3 are of the same size as the edge length D.

The one of the two groove walls of the transverse groove 12 is formed by a spring web 13 which is formed on the groove base and which at its free web end has a latching element 14, in this case, for example, in the form of a profiled protrusion running transversely to the longitudinal axis 3. The main body 2 has a latching element 15 on one (4c) of the two longitudinal faces 4b, 4c, the transverse groove 11 being open relative thereto transversely to the longitudinal axis 3 and said latching element being complementary to the latching element 14 of the spring web 13, in this case, for example, in the form of a profiled indentation running along the entire longitudinal face 4c.

The first, the second and the third mounting faces 8c in each case have the same latching arrangement of a plurality of latching elements arranged around a center, in this case, for example, in the form of latching protrusions and latching recesses 16, 17. The latching arrangement has a multiple rotational symmetry relative to the center and in this case is a circle on which the latching protrusions 16 and latching recesses 17 are alternately arranged at 45° angular spacings, whereby a rotational symmetry of order 4 is produced here. The center of the latching arrangement is formed by a through-hole 18 in the respective mounting face 8a-8c.

The main body 2 also has a fourth mounting face 8d formed by the longitudinal face 4d, with a comb-like surface profile 19 when viewed in the transverse direction. The comb-like surface profile 19 has alternately high and low comb profile stepped portions 20a, 20b with in each case the same profile width.

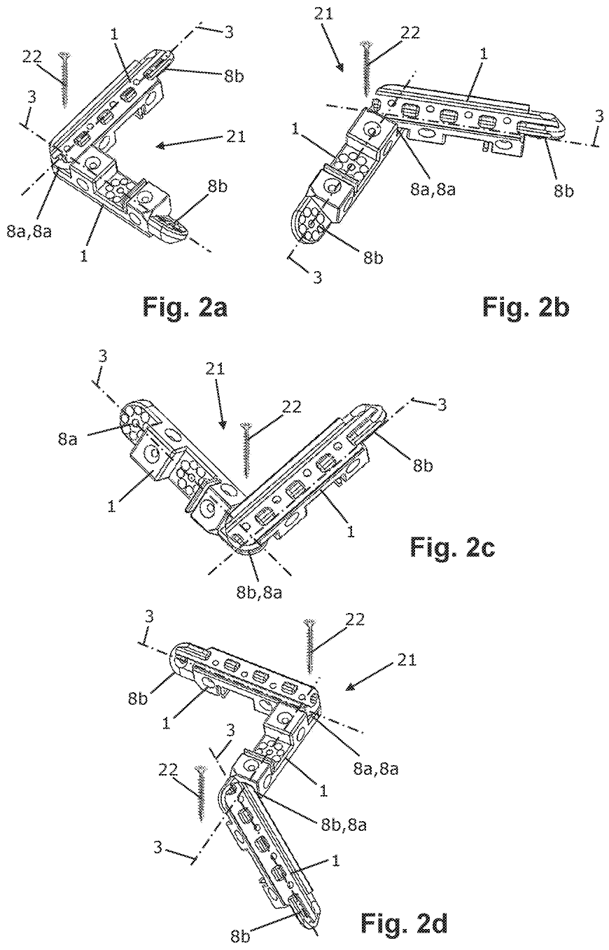

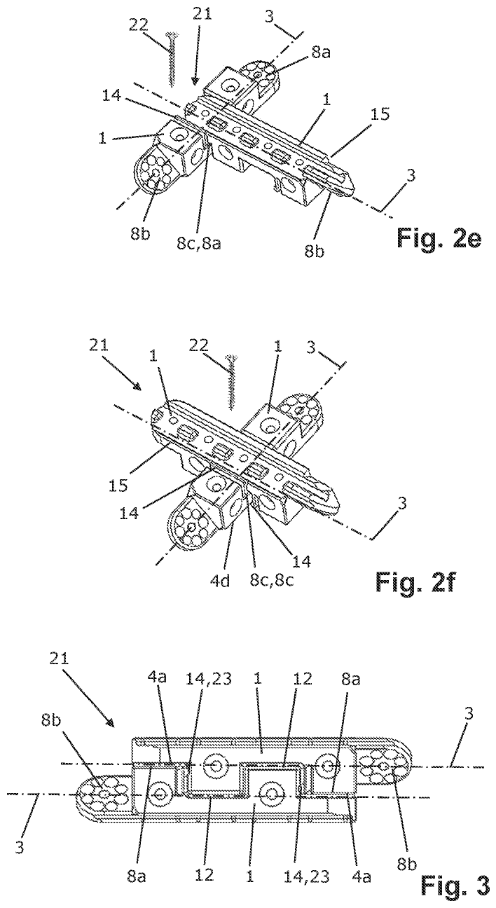

FIGS. 2a-2f show a connection fitting 21 comprising two or three fitting parts 1 which bear against one another by means of their first, second or third mounting faces 8a-8c and optionally are connected together by means of screws 22.

In FIG. 2a two fitting parts 1 are oriented perpendicular to one another with their longitudinal axes 3 and bear against one another with their first mounting faces 8a.

In FIG. 2b two fitting parts 1 are oriented at 135° to one another with their longitudinal axes 3 and bear against one another with their first mounting faces 8a.

In FIG. 2c two fitting parts 1 are oriented perpendicular to one another with their longitudinal axes 3 and bear against one another with a first and a second mounting face 8a, 8b.

In FIG. 2d three fitting parts 1 are oriented relative to one another in a zigzag manner with their longitudinal axes 3. The upper and the central fitting parts 1 in FIG. 2d are oriented perpendicular to one another with their longitudinal axes 3 and bear against one another with their first mounting faces 8a, 8b. The lower and the central fitting parts 1 are oriented relative to one another with their longitudinal axes 3 by 135° and bear against one another with a first and a second mounting face 8a, 8b.

In FIG. 2e two fitting parts 1 are oriented perpendicular to one another with their longitudinal axes 3 and bear against one another with a first and a third mounting face 8a, 8c. The profiled protrusion 14 of the spring web 13 of the one fitting part 1 engages in the profiled indentation 15 of the other fitting part 1, whereby the two fitting parts 1 are latched together.

In FIG. 2f two fitting parts 1 are oriented perpendicular to one another with their longitudinal axes 3 and bear against one another with their third mounting faces 8c, 8c, by the transverse grooves 12 of the two fitting parts 1 which are arranged so as to be rotated relative to one another by 90° being inserted into one another. On the one hand, the profiled protrusion 14 of the spring projection 13 of the lower fitting part 1 in FIG. 2f engages in the profiled indentation 15 of the upper fitting part 1 and, on the other hand, the profiled protrusion 14 of the spring projection 13 of the upper fitting part 1 engages behind or below the lower stepped portion 20b of the longitudinal face 4d of the lower fitting part 1, whereby the two fitting parts 1 are latched together twice.

In FIGS. 2a-2f the latching protrusions and latching recesses 16, 17 of the mounting faces which bear against one another in the desired angular orientation engage in one another in each case. A screw 22 is screwed through the through-holes 18 of the mounting faces which bear against one another, whereby the mounting faces and thus the two fitting parts 1 are secured in their latched angular orientation.

FIG. 3 shows a connection fitting 21 comprising two fitting parts 1 which are oriented with their longitudinal axes 3 parallel to one another and are inserted into one another with their longitudinal faces 4a. The longitudinal faces 4a of the fitting parts 1 have a comb-like insertion profile due to the stepped-back first mounting face 8a and the transverse groove 12, the groove base thereof being at the same height as the first mounting face 8a. The two fitting parts 1 are inserted into one another with their comb-like insertion profiles. The profiled protrusion 14 on the spring projection 13 of the one fitting part engages into a latching indentation 23 (FIG. 1c) of the other fitting part which is present on the front face of the step between the first mounting face 8a and the longitudinal face 4a, whereby the two fitting parts 1 are latched together twice. Fastening screws 22 can be screwed through the through-holes 6, 18, in order to fasten the two fitting parts 1 to one another. This connection fitting 21 can be used, for example, as a double fitting for two furniture panels.

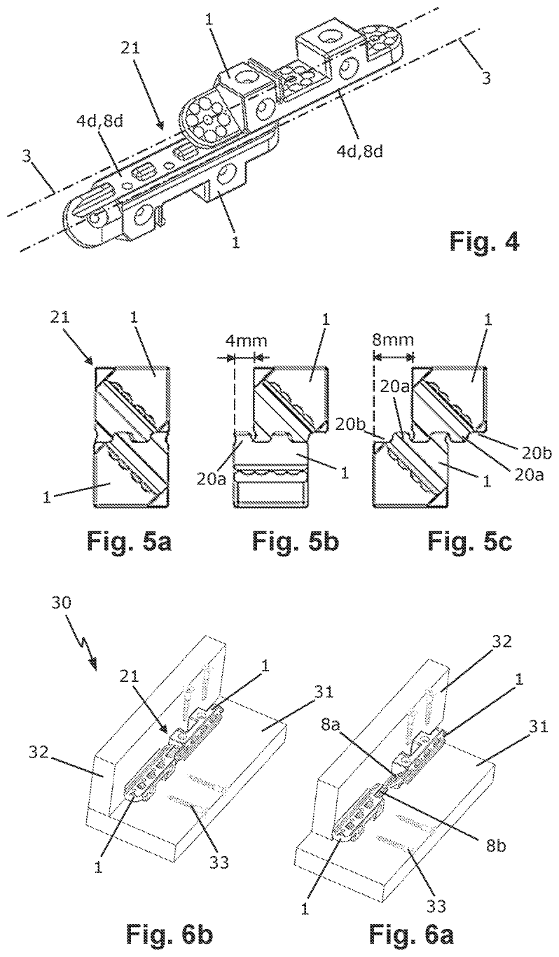

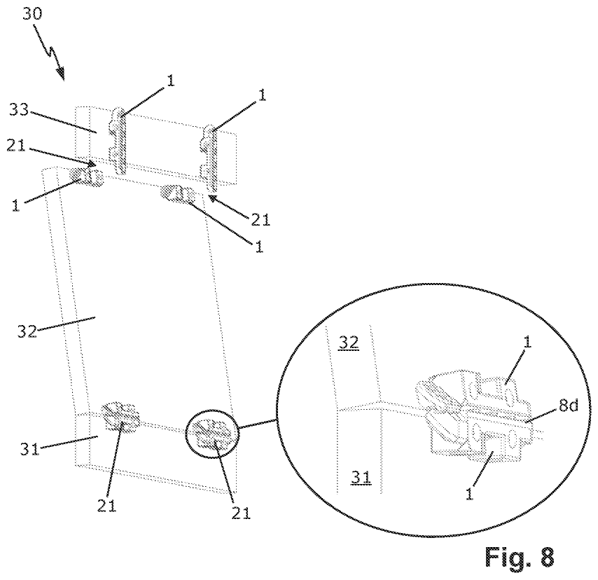

FIG. 4 shows a connection fitting 21 comprising two fitting parts 1 which are oriented parallel to one another with their longitudinal axes 3 and engage in one another with their comb-like mounting faces 8d. The high comb profile stepped portions 20a of the one fitting part 1 engage in the low comb profile stepped portions 20b of the other fitting part 1. As shown in FIGS. 5a-5c, depending on which high and low comb profile stepped portions 20a, 20b engage in one another, the fitting parts 1 can be offset by a different transverse offset of 0 mm (FIG. 5a), 4 mm (FIG. 5b) or 8 mm (FIG. 5c). In order to achieve the transverse offset of 4 mm, in FIG. 5b the lower fitting part 1 is arranged laterally reversed or turned by 180° relative to FIGS. 5a, 5c.

Rather than being open on both sides in the transverse direction, as shown in the exemplary embodiments, alternatively the transverse groove 12 can be open only on one side in the transverse direction. Rather than the square envelope 7 shown in the exemplary embodiments, when viewed in the direction of the longitudinal axis 3, the main body can also have an outer contour with a rectangular or polygonal envelope. Rather than the four longitudinal faces 4a-4d shown in the exemplary embodiments, the main body 2 can also have fewer longitudinal faces, for example, only one, two or three longitudinal faces. Rather than four mounting faces 8a, 8b shown in the exemplary embodiments, the main body 2 can also have fewer mounting faces, for example, only one, two or three mounting faces. Rather than screwing onto a part, the fastening face of the fitting part 1 can also be adhesively bonded to the part.

Additionally, with only a single fitting part 1, a corner connection between two parts can be formed, by two rectangular longitudinal faces being screwed in each case onto the parts.

The parts fastened to the respective fitting parts 1 are not shown in FIGS. 1 to 5. The parts can be oriented, for example, at 45°, 90°, 135° or 180° relative to one another or form a T-joint.

A furniture arrangement 30 comprising two panel-shaped furniture parts 31, 32 which are positioned perpendicular to one another and which are connected together by means of the connection fitting 21 are shown in FIGS. 6a, 6b. As shown in FIG. 6a, the one first fitting part 1 and the other second fitting part 1 are screwed with their longitudinal face 4a onto the one first furniture part 31 or the other second furniture part 32 in each case by means of screws 33 which pass through the through-holes 6. Then the furniture parts 31, 32 which are perpendicular to one another-with the longitudinal axes 3 of the two fitting parts 1 oriented parallel to one another-are displaced until the oblique second mounting faces 8b of the two fitting parts 1 bear against one another and are latched together by means of the latching elements 16, 17 (FIG. 6b). The second mounting faces 8b mutually engage below one another, whereby the two furniture parts 31, 32 are fixed to one another. Overall, therefore, this produces a rigid and strong corner connection.

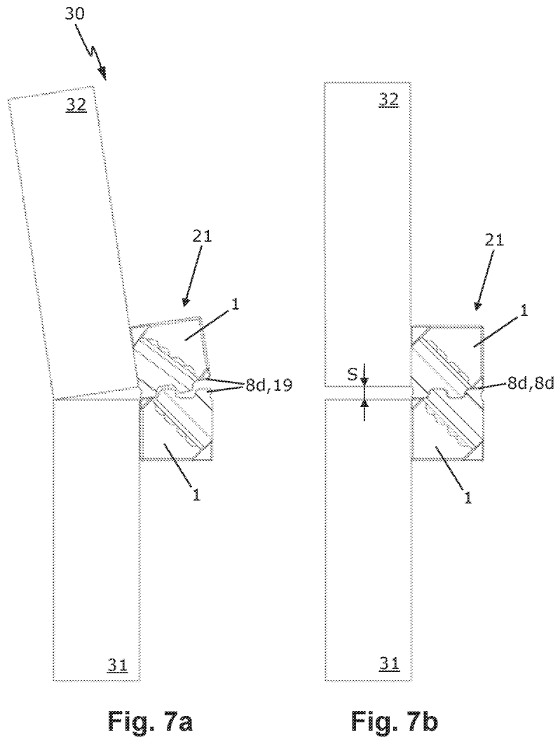

FIGS. 7a, 7b show a furniture arrangement 30 comprising two furniture parts 31, 32 which are adjusted by means of the connection fitting 21 to a gap dimension s of 4 mm. The fitting parts 1 are screwed in each case with their longitudinal face 4c onto the panel sides of the furniture parts 31, 32, wherein the lower fitting part 1 in FIG. 7 protrudes upwardly over the upper edge of the lower furniture part 31 and the upper fitting part 1 protrudes downwardly over the lower edge of the lower furniture part 31 and namely with a total overhang corresponding to the gap dimensions. The two furniture parts 31, 32 are initially positioned against one another front face to front face and fitting part to fitting part 1, i.e., obliquely (FIG. 7a). Then the two fitting parts 31, 32 are pivoted into their flush-mounted position, wherein as shown in FIG. 5a, the high and low comb profile stepped portions 20a, 20b of the two fitting parts 31, 32 engage in one another (FIG. 7b). The pivot axis is defined by the fitting parts 1 which engage in one another.

FIG. 8 shows a furniture arrangement 30 comprising three furniture parts 31, 32, 33, wherein the central furniture part 32 is fastened in each case by two connection fittings 21 to the two other furniture parts. The two lower connection fittings 21 are oriented as in FIG. 7 and the two upper connection fittings 21 are oriented as in FIG. 2e, and fastened in each case to the furniture parts. Initially, the central furniture part 32, as shown in FIG. 7a, is placed obliquely onto the lower furniture part 31 by means of the two lower connection fittings 21. Then the central furniture part 32 is pivoted into the position flush-mounted with the other two furniture parts 31, 33, whereby the two fitting parts 1 of the upper connection fittings 21 are latched together. Then the fitting parts 1 of the connection fittings 21 can be secured to one another by means of screws 22.

What is claimed is:

1. A fitting part of a connection fitting configured for connecting two parts, having a main body with a longitudinal axis, with at least one longitudinal face which forms a planar fastening face for bearing against and fastening to a part to be connected, and with at least one mounting face for bearing against a counter-mounting face of a further fitting part of the connection fitting, wherein the main body has at least one of the following mounting faces:
a first mounting face which is disposed on a first longitudinal end of the main body, is arranged parallel or at an angle to the fastening face, and has at least one latching element;
a second mounting face, which is disposed on a second longitudinal end of the main body, is arranged with respect to the fastening face at an inclination about the longitudinal axis or an axis extending parallel thereto, and has at least one latching element;
a third mounting face, which is formed by a groove base of a transverse groove in the main body, said groove being open on one or both sides, is arranged parallel or at an angle to the fastening face and has at least one latching element; and
a fourth mounting face, which is formed on another longitudinal face of the main body, is arranged parallel or perpendicular to the fastening face and, when viewed in the transverse direction, has a comb-like surface profile.

2. The fitting part as claimed in claim 1, wherein, when viewed in the direction of the longitudinal axis, the main body has an outer contour with a rectangular envelope.

3. The fitting part as claimed in claim 1, wherein the first mounting face is disposed on a first longitudinal end of the main body and the second mounting face is disposed on a second longitudinal end of the main body.

4. The fitting part as claimed in claim 1, wherein the first, the second and/or the third mounting faces in each case have the same latching arrangement of a plurality of latching elements.

5. The fitting part as claimed in claim 1, wherein the first and the second mounting face in each case are formed by a stepped portion of the main body.

6. The fitting part as claimed in claim 1, wherein the thickness of the one or more longitudinal ends is half as high as the thickness of the main body.

7. The fitting part as claimed in claim 1, wherein the width of the first and/or second longitudinal end is equal to the width of the main body.

8. The fitting part as claimed in claim 1, wherein one of the two groove walls of the transverse groove is formed by a spring web which is formed on the groove base and which at its free web end has a latching element.

9. The fitting part as claimed in claim 1, wherein the first and the third mounting face are formed on the same longitudinal face of the main body and, when viewed in the longitudinal direction of the main body, form a comb-like insertion profile of the longitudinal face.

10. The fitting part as claimed in claim 1, wherein the at least one longitudinal face has at least one through-hole.

11. The fitting part as claimed in claim 1, wherein the comb-like surface profile has alternately high and low profile stepped portions with in each case the same profile width.

12. The connection fitting comprising at least two fitting parts as claimed in claim 11.

13. An arrangement comprising the two parts, which are connected together by means of the connection fitting as claimed in claim 12, wherein a first fitting part of the connection fitting bears with its fastening face against the one first part and is fastened thereto and a second fitting part of the connection fitting bears with its fastening face against the other second part and is fastened thereto and wherein the first, the second or the third mounting face of the first fitting part and the first, the second or the third mounting face of the second fitting part bear against one another and are latched together by means of the latching elements, or the fourth mounting face of the first fitting part and the fourth mounting face of the second fitting part bear against one another and engage in one another by means of the comb-like surface profiles.

14. A fitting part of a connection fitting configured for connecting two parts, having a main body with a longitudinal axis, with at least one longitudinal face which forms a planar fastening face for bearing against and fastening to a part to be connected, and with at least one mounting face for bearing against a counter-mounting face of a further fitting part of the connection fitting, wherein the main body has at least one of the following mounting faces:
a first mounting face which is disposed on a first longitudinal end of the main body, is arranged parallel or at an angle to the fastening face and has at least one latching element;
a second mounting face, which is disposed on a second longitudinal end of the main body, is arranged with respect to the fastening face at an inclination about the longitudinal axis or an axis extending parallel thereto, and has at least one latching element;
a third mounting face, which is formed by a groove base of a transverse groove in the main body, said groove being open on one or both sides, is arranged parallel or at an angle to the fastening face and has at least one latching element; and
a fourth mounting face, which is formed on another longitudinal face of the main body, is arranged parallel or perpendicular to the fastening face and, when viewed in the transverse direction, has a comb-like surface profile;
wherein the main body is cuboidal at least in some portions with four longitudinal faces, wherein one, or more or all four longitudinal faces in each case form a fastening face.

15. The connection fitting comprising at least two fitting parts as claimed in claim 14.

16. An arrangement comprising the two parts, which are connected together by means of the connection fitting as claimed in claim 15, wherein a first fitting part of the connection fitting bears with its fastening face against the one first part and is fastened thereto and a second fitting part of the connection fitting bears with its fastening face against the other second part and is fastened thereto and wherein the first, the second or the third mounting face of the first fitting part and the first, the second or the third mounting face of the second fitting part bear against one another and are latched together by means of the latching elements, or the fourth mounting face of the first fitting part and the fourth mounting face of the second fitting part bear against one another and engage in one another by means of the comb-like surface profiles.

17. A fitting part of a connection fitting configured for connecting two parts, having a main body with a longitudinal axis, with at least one longitudinal face which forms a planar fastening face for bearing against and fastening to a part to be connected, and with at least one mounting face for bearing against a counter-mounting face of a further fitting part of the connection fitting, wherein the main body has at least one of the following mounting faces:
a first mounting face which is disposed on a first longitudinal end of the main body, is arranged parallel or at an angle to the fastening face and has at least one latching element;
a second mounting face, which is disposed on a second longitudinal end of the main body, is arranged with respect to the fastening face at an inclination about the longitudinal axis or an axis extending parallel thereto, and has at least one latching element;
a third mounting face, which is formed by a groove base of a transverse groove in the main body, said groove being open on one or both sides, is arranged parallel or at an angle to the fastening face and has at least one latching element; and
a fourth mounting face, which is formed on another longitudinal face of the main body, is arranged parallel or perpendicular to the fastening face and, when viewed in the transverse direction, has a comb-like surface profile;
wherein a groove width of the transverse groove extending in the direction of the longitudinal axis is equal to a groove length of the transverse groove extending transversely to the longitudinal axis and/or equal to the width of the one or more longitudinal ends.

18. The connection fitting comprising at least two fitting parts as claimed in claim 17.

19. An arrangement comprising the two parts, which are connected together by means of the connection fitting as claimed in claim 18, wherein a first fitting part of the connection fitting bears with its fastening face against the one first part and is fastened thereto and a second fitting part of the connection fitting bears with its fastening face against the other second part and is fastened thereto and wherein the first, the second or the third mounting face of the first fitting part and the first, the second or the third mounting face of the second fitting part bear against one another and are latched together by means of the latching elements, or the fourth mounting face of the first fitting part and the fourth mounting face of the second fitting part bear against one another and engage in one another by means of the comb-like surface profiles.
